(19) United States
(12) Patent Application Publication
(10) Pub. No.: US 2011/0145054 A1
(43) Pub. Date: Jun. 16, 2011

(54) SYSTEM AND METHOD FOR ELECTRONICALLY CAPTURING DIGITAL COUPONS WITH PRINTING AND REDEMPTION AT A TARGETED RETAILER

(76) Inventors: Vijay Raghavan Chetty, Santa Monica, CA (US); Charles Frederic Paul, Incline Village, NV (US)

(21) Appl. No.: 12/909,585

(22) Filed: Oct. 21, 2010

Related U.S. Application Data
(60) Provisional application No. 61/285,896, filed on Dec. 11, 2009.

(51) Int. Cl. G06Q 30/00; G06F 9/445; G06F 15/16

(52) U.S. Cl. 705/14.38; 705/1.1; 705/16; 717/174; 709/202; 713/100

(57) ABSTRACT

According to an embodiment of the invention, a method is performed in which a print configuration for an electronic device is saved. Therefore, a virtual print driver is installed (or activated) on the electronic device. The virtual print driver operates so that, when a digital coupon image is selected for printing, the digital coupon image is captured and re-transmitted over a network for remote storage in lieu of the digital coupon image being printed locally.

### 1. FIELD

Embodiments of the invention relate to the field of digital coupon management. In particular, certain embodiments of the invention relate to a system and method for capturing digital coupons from any website by a user and making these digital coupons available for redemption and printing at one or more retailers designated by the user.

### 2. GENERAL BACKGROUND

Even in today's digital world, many coupons and retail promotions distributed digitally, via the Internet and mobile technologies, are still printed on paper by the user and presented to retailers for redemption. Manufacturers and retailers distribute billions of dollars worth of digital coupons each year, via the Internet and mobile technology platforms, with very low redemption rates. Digital coupon distribution and redemption schemes are only marginally effective because numerous activities must be performed by the user before a digital coupon is redeemed. These activities include printing the coupon at home/work, storing the paper coupon, remembering to bring and present the paper coupon to the cashier at the store for redemption.

In general, a Point-of-Sale (POS) system at the retail store typically validates presented paper coupons to the products purchased by the consumer using a family code database or an offer registry to ensure that the consumer bought a valid product as defined within the barcodes printed on the paper coupon. A “family code database” provides a list of products that are associated with a particular family code and are eligible for a prescribed discount. An “offer registry” is a list of coupons identifying those products that apply for each coupon. The retailer collects all paper coupons redeemed by customers and sends them to a retailer's clearing agent for collection.

Under the current system, retail stores distribute magnetic media and/or barcode based plastic cards to store customers, generally known as “loyalty cards.” Retailers use these loyalty cards to identify their customers, capture transaction details by customer, and utilize the resultant information to enhance the quality of their marketing programs. While there are numerous analytical tools available to analyze and evaluate customer transaction details and determine what type and amount of discounts will be most effective for an individual customer or a segment of customers, retailers lack solutions that can enable them to deliver variable amounts of discounts to each customer or customer segments and automatically redeem them in real time at checkout.

Marketing programs are not being optimized since many individuals do not use loyalty cards and Internet coupons are redeemed at a very low rate as mentioned above. Hence, it would be advantageous to provide a user-controlled digital coupon capturing mechanism with printing and redemption at the retailer in order to increase digital coupon redemption, increase commerce at the retailer and increase the amount of information involving customer purchasing decisions, while at the same time, reduce the propensity for fraud associated with paper coupons. It would also provide coupon issuers the ability to distribute variable amounts of discounts to targeted users based on their buying behavior and enhance the quality of their marketing programs.

### BRIEF DESCRIPTION OF THE DRAWINGS

The invention may best be understood by referring to the following description and accompanying drawings that are used to illustrate embodiments of the invention.

FIG. 1 is a first exemplary embodiment of a Coupon Redemption System (CRS).

FIG. 2A is a second exemplary embodiment of the Coupon Redemption System (CRS).

FIG. 2B is a third exemplary embodiment of the Coupon Redemption System (CRS).

FIG. 3A is an exemplary embodiment of the architecture of the electronic device of FIGS. 1 and 2.

FIG. 3B is an exemplary embodiment of operations for configuring the electronic device of FIG. 3A to support digital coupon re-transmission.

FIGS. 4A-4G are exemplary embodiments of POS controller and POS terminals that support digital coupon capturing, distribution and validation by the CRS.

FIG. 5 is an exemplary embodiment of the digital coupon distribution process supported by the coupon redemption system.

### DETAILED DESCRIPTION

Exemplary embodiments of the invention relate to a system and method for capturing digital coupons from any website by a user and, in lieu of enabling the printing of these coupons, seamlessly routing these digital coupons to make them available for redemption and printing at one or more retailers designated by the user.

According to one embodiment of the invention, digital coupons are accessed by the user via an electronic device that is in communication with one or more servers forming a network. The network may be a private network or a public network (e.g., the Internet) and the communications may be over a medium that supports wireless communications (e.g., infrared “IR”, laser, radio frequency, cellular, satellite, etc.) or wired communications (e.g., electrical wire, optical fiber, cable, etc.). Thereafter, these digital coupons are uploaded and remotely stored for later retrieval by a retailer, with redemption upon compliance with the terms and conditions outlined by the digital coupon. Those redeemed digital coupons are printed at the retailer and subsequently submitted in accordance with standard clearing processes.

In the following description, certain terminology is used to describe certain features of the invention. For example, the term “retailer” constitutes an entity that is involved with the selling of items, namely products and/or services. An “electronic device” is a device that processes input data and supports network connectivity to upload digital coupons into a storage unit (e.g., any local or remote device that provides data storage such as a server, dedicated hard disk drive array, etc.) that is accessible by one or more retailers. Examples of an electronic device include, but are not limited or restricted to a computer (e.g., desktop, laptop, netbook, mainframe with one or more terminals), a personal digital assistant, a cellular telephone, a kiosk, or the like.

The term “digital coupon” generally describes information that may be used by the user to obtain a discounted price on the purchase of an item. For instance, as an illustrative embodiment of the invention, this information may be a printable, digital image of the coupon, where the image includes data that identifies the item covered by the coupon and its redemption value. This data may be in the form of alphanumeric text or a barcode for example. Alternatively, as another illustrative embodiment of the invention, the digital coupon simply may be one or more alphanumeric (or numeric-only) characters or even a string of bits that specify at least the item covered by the coupon and its redemption value. As optional information, the digital coupon may contain a manufacturer code for the item and a family code as described below.

According to one embodiment of the invention, when inserted within the digital coupon image, the barcode of the digital coupon may be in accordance with any one of the commonly accepted barcode formats such as Universal Product Code (UPC), EAN, Code 39, Code 128, GS1 DataBar, or the like. Although not shown, the barcode comprises a plurality of code fields including, but not limited or restricted to one or more of the following: (1) an identifier of the type of barcode (e.g., UPC barcode or an EAN-99 (in-store) barcode); (2) a manufacturer code (e.g., 5-digits); (3) a family code (e.g., 3-digits) to identify a specific group of items; (4) a value code (e.g., 2-digits) that specifies a redemption value (e.g., monetary value or credit) and perhaps a limit on redemptions; and (5) a checksum (e.g., a 1-digit check digit calculated from all the previous fields that is used to ensure that the barcode was successfully read). A supplemental barcode extends the information on the coupon to include one or more of the following: (1) the manufacturer's number system character (e.g., 1-digit); (2) the offer code (e.g., 5-digits); and the coupon expiration date (e.g., mmyy). In addition, the GS1 DataBar, that is in the process of being implemented within the industry, greatly extends the information contained in the barcode to include a variable manufacturer code (up to 12-digits), a 6-digit offer code, a full expiration date, greater flexibility in specifying validation criteria, and additional coupon value options in any amount up to $999.99.

Herein, the terms “logic”, “unit” and “module” constitute hardware and/or software. In general terms, hardware constitutes physical components while software constitutes code or a series of coded instructions that may be implemented as firmware or may be implemented as part of an operating system, an application program, a downloadable applet, a routine, or the like. For instance, a module can be stored in any type of machine readable medium and executed by a processing unit. Examples of “machine readable medium” include a programmable electronic circuit, a semiconductor memory device including volatile memory (e.g., random access memory, etc.) or non-volatile memory (e.g., any type of read-only memory “ROM”, flash memory), an optical disk (e.g., compact disk or digital video disc “DVD”), a hard drive disk, a portable drive (e.g., Universal Serial Bus “USB” flash drive), or the like. Examples of a “processing unit” comprise a digital signal processor, a general microprocessor, a micro-controller, a state machine, an application specific integrated circuit, or the like.

A. Exemplary System Architectures

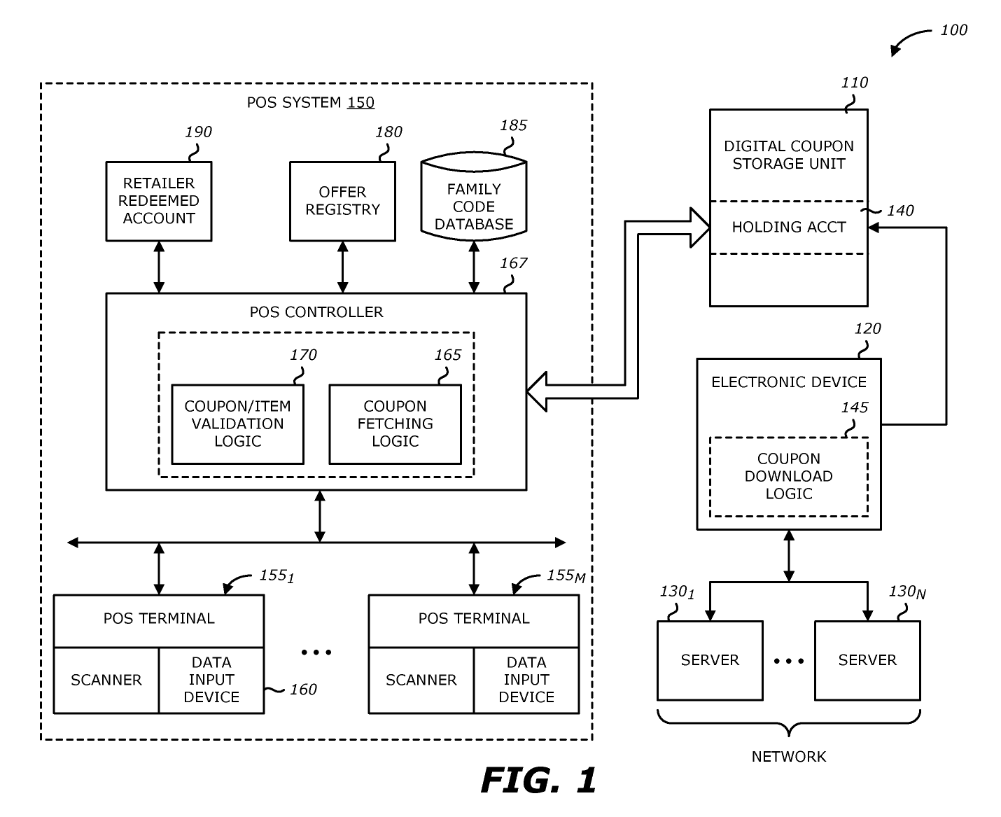

Referring now to FIG. 1, a first exemplary embodiment of a Coupon Redemption System (CRS) 100 is illustrated. CRS 100 comprises a storage unit 110 that is in communication with and configured to receive and store digital coupons uploaded by a registered user via an electronic device 120. In other words, as described below, a user initially registers by accessing a website and providing demographic and/or other information such as two or more of the following: name, age, mailing address, phone number, biometric (e.g., fingerprint image, retinal scan, facial geometry), credit card number, loyalty card number, personal identification number (PIN), income range, and/or an electronic mail (email) address. Of course, in lieu of accessing the website, the user may register by simply filling out paperwork that is sent to an agency that registers the user.

According to this embodiment of the invention, after registration, a storage area 140 is allocated for the registered user (or group of users) within storage unit 110. Herein, both storage unit 110 and user(s)-specific storage area 140 may be referred to as “digital coupon storage unit” and “holding account,” respectively.

According to one embodiment of the invention, digital coupon storage unit 110 constitutes one or more servers that not only are accessible by a retailer, but also are adapted to store digital coupons that are uploaded by a registered user. However, in lieu of a server implementation, it is contemplated that digital coupon storage unit 110 may be any form of a data storage that is accessible by a retailer and is configured to receive uploaded digital coupons from one or more users who may be current, potential or former customers of the retailer.

As shown in FIG. 1, it is evident from the illustrative embodiment that one or more digital coupons are accessible from one or more (N) servers 130₁-130_{N} (N≧1) forming a network. According to one embodiment of the invention, servers 130₁-130_{N} produce a web site that allows particular users or the public at large to select and download digital coupons from that web site. As an example, upon accessing this particular web site, electronic device 120 has access to images of digital coupons hosted by servers 130₁-130_{N}.

Upon selecting one or more digital coupon images for printing, coupon capturing logic 145 (e.g., an application downloaded by electronic device 120 for coupon management) operates to re-route the digital coupon(s) to (coupon) holding account 140, which is resident at digital coupon storage unit 110. According to one embodiment of the invention, this routing is seamless without requiring further actions by the user. The digital coupons may be subsequently accessed by a point-of-sale (POS) system 150 at the retailer.

According to another embodiment of this invention, besides allowing user to upload digital coupons into holding account 140, it is contemplated that the coupon issuers (e.g., retailers, manufacturers and third parties) registered to participate in this coupon network, may be given access to the users' holding accounts to load any coupon directly into each user's holding account. Alternately, these coupon issuers may electronically transmit their coupons to digital coupon storage unit 110 for subsequent distribution and allocation to the respective users holding accounts based on certain criteria defined by the coupon issuers.

Upon checkout, a point-of-sale (POS) terminal 155ⱼ (j=1 . . . , or M, where M≧1) identifies the user based on information received via a data input device 160 (e.g., keypad, touch screen, barcode or magnetic strip obtained via a card scanner using a loyalty card for example).

After such identification, POS terminal 155ⱼ signals a coupon fetching logic 165, which is controlled by POS controller 167, to fetch either the digital coupons retained in holding account 140 or information representative of these digital coupons. Regardless, the fetched digital coupons or information is used to determine if any of the stored digital coupons can be redeemed. The digital coupons or fetched information may be stored locally at POS controller 167, may remain in holding account 140 if information from the digital coupons can be quickly obtained, or transferred to another storage location that provides reduced fetching latency.

According to one embodiment of the invention, as items are scanned at POS terminal 155, coupon/item validation logic 170, when implemented and working in combination with coupon fetching logic 165, is configured to validate the digital coupons stored in holding account 140 to the items purchased using either an offer registry 180 or a family code database 185. Coupon fetching logic 165 and coupon/item validation logic 170 may be implemented as separate logic or may simply represent different functionality within a single unit or module.

If coupon/item validation logic 170 has access to offer registry 180, it uses offer registry 180 to validate digital coupons in holding account 140. Without access to offer registry 180, however, coupon/item validation logic 170 uses family code database 185 to validate the digital coupon.

Coupon/item validation logic 170 reviews the selected digital coupons to see if ‘valid’ items in sufficient quantities have been purchased for redemption. When ‘valid’ items in sufficient quantities have been purchased to redeem a coupon, logic 170 transmits the information from the digital coupon to POS terminal 155, just as if the coupon had been scanned from paper. Thereafter, the redeemed coupon is removed from the user's holding account 140 so it cannot be reused. The digital coupon is then added to the retailer's account of redeemed coupons (hereinafter referred to as “retailer redeemed account 190”) for subsequent printing and distribution to the retailer's clearing agent. Any items used to redeem a coupon are marked as such so that they may not be used to redeem subsequent coupons.

In the event that an item required for the redemption of a coupon be voided or returned within the transaction, the coupon redemption will be reversed, and the digital coupon will be returned to the user's holding account 140. The digital coupon will be removed from retailer redeemed account 190, and any other items originally used to redeem the digital coupon will be unmarked and made available for other coupon redemptions.

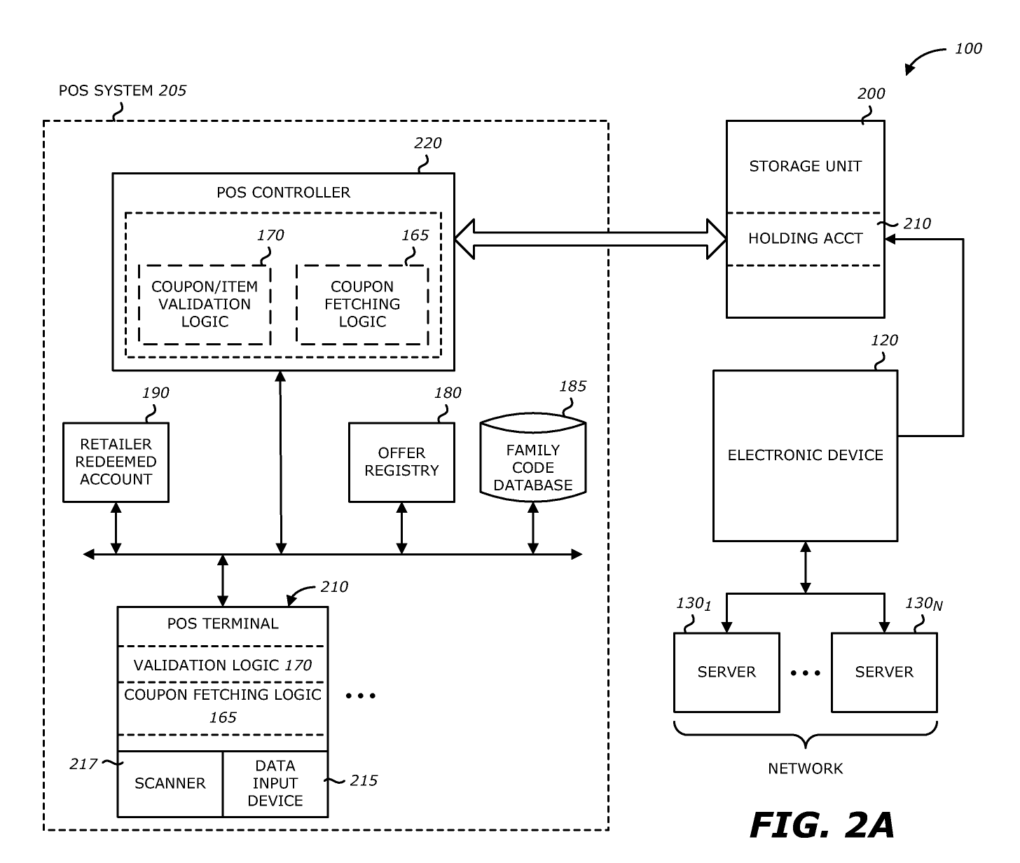

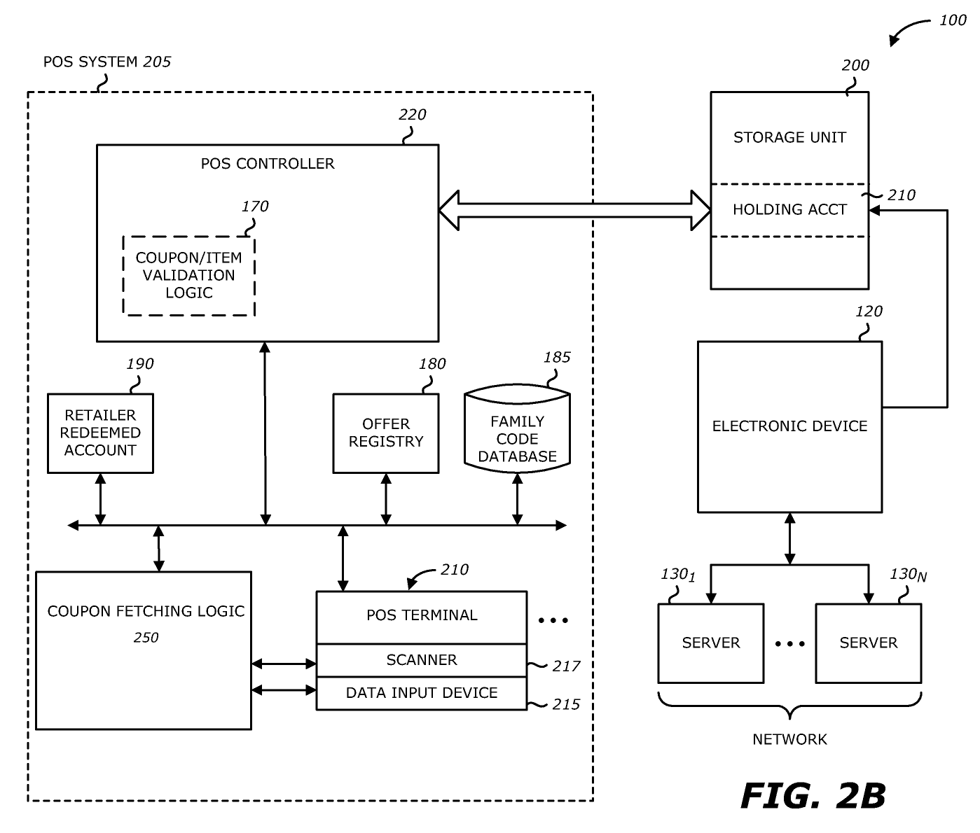

Referring now to FIG. 2A, a second exemplary embodiment of Coupon Redemption System (CRS) 100 is illustrated. CRS 100 comprises at least one storage unit 200 that are accessible by a point-of-sale (POS) system 205 that is implemented at the retailer. The retailer is automatically selected or selected by the user to receive the uploaded digital coupons.

More specifically, the digital coupons are uploaded into storage unit 200 in response to an election by the user to print the digital coupon. Storage unit 200 may be local to the retailer or may be placed off-site. Regardless of the placement of storage unit 200, it is contemplated that limiting or precluding the retailer's to the digital coupon image may be desired.

Each user is assigned an amount of storage within storage unit 200. This amount of storage is referred to as the user's “holding account.” Information associated with the digital coupon image may be subsequently accessed by POS system 205 or POS terminal 210 at the retailer, depending on the POS configuration.

Upon checkout, POS terminal 210 identifies the user based on information received via a data input device 215 (e.g., keypad, touch screen, barcode or magnetic strip obtained via a card scanner) or scanner 217. After such identification, POS terminal 210 (or POS controller 220) fetches the digital coupons previously retained in storage unit 200 for possible redemption. The fetching of the digital coupons may be performed by coupon fetching logic 165 implemented within POS terminal 210 (or POS controller 220) as described below.

1. Secondary Validation by Third Party

According to one embodiment of the invention, as items are scanned at POS terminal 210, coupon/item validation logic 170 implemented at POS terminal 210 (or at POS controller 220) validates the digital coupons to the items purchased using either offer registry 180 or family code database 185. Examples of implementations of logic 170 may include, but is not limited or restricted to software uploaded into POS terminal 210, hardware implemented as part of POS system 205, or software executed by a processing unit within the POS controller 220.

Furthermore, validation logic 170 reviews the digital coupons to see if ‘valid’ items in sufficient quantities have been purchased for redemption. When ‘valid’ items in sufficient quantities have been purchased to redeem a coupon, logic 170 causes the redeemed coupon to be marked as ‘redeemed’ or removed from the user's holding account in storage unit 200 so it cannot be reused. The digital coupon is then added to retailer redeemed account 190. Any items used to redeem a coupon are marked as such so that they may not be used to redeem subsequent coupons.

In the event that an item required for the redemption of a digital coupon be voided or returned within the transaction, the coupon redemption will be reversed, and the digital coupon will be returned to the user's holding account. The digital coupon will be removed from the retailer redeemed account 190, and any other items originally used to redeem the digital coupon will be unmarked and made available for other coupon redemptions.

2. No Third-Party Validation

According to another embodiment of the invention, after identification of the user, coupon fetching logic 165 implemented within POS terminal 210 (or POS controller 220) fetches the digital coupons previously retained in storage unit 200 for possible redemption. These digital coupons are not validated by validation logic 170 since such logic would not be implemented within POS system 205. Rather, the digital coupons are merely downloaded to POS system 205 for validation by POS and subsequent redemption. Hence, a single tiered validation by POS terminal 210 is conducted.

3. No Third Party Validation but Printing Limits

According to yet another embodiment of the invention, after identification of the user, coupon fetching logic 165 implemented within POS terminal 210 (or POS controller 220) fetches the digital coupons previously retained in storage unit 200 for possible redemption. Similarly, the digital coupons are not validated by coupon/item validation logic 170 with POS terminal 210 being configured to solely perform the validation. However, printing of the digital coupon by the retailer responsible for handling the validation and redemption is controlled by logic implemented at the retailer by a third party.

Referring now to FIG. 2B, a third exemplary embodiment of Coupon Redemption System (CRS) 100 is illustrated. Similar to FIG. 2A, CRS 100 comprises at least one storage unit 200 that are accessible by a point-of-sale (POS) system 205 that is implemented at the retailer. The retailer is automatically selected or selected by the user to receive the uploaded digital coupons.

More specifically, the digital coupons are uploaded into storage unit 200 in response to an election by the user to print the digital coupon. Storage unit 200 may be local to the retailer or may be placed off-site. Regardless of the placement of storage unit 200, it is contemplated that limiting or precluding the retailer's to the digital coupon image may be desired.

Each user is assigned an amount of storage within storage unit 200, which is referred to as the user's “holding account.” However, unlike CRS 100 of FIG. 2A, according to this embodiment of the invention, coupon fetching logic 250 is a separate component that monitors scanned and weighed/keyed items by POS terminal 210 at the retailer and uploads corresponding digital coupons to POS terminal 210.

More specifically, upon checkout, coupon fetching logic 250 monitors user identification information entered by the user at POS terminal 210 via its data input device 215 (e.g., keypad, touch screen, barcode or magnetic strip obtained via a card scanner) and downloads this information to POS controller 220. POS controller identifies the user and accesses digital coupons stored in the identified user's holding account.

Additionally, coupon fetching logic 250 monitors information associated with the items being scanned or weighed/keyed at POS terminal 210 and routes this information to POS controller 220. In response, POS controller 220 retrieves one or more digital coupons applicable to the scanned or weighed item, and where applicable, validates the digital coupon before downloading the validated digital coupon to coupon fetching logic 250. Thereafter, coupon fetching logic 250 uploads the validated digital coupon to POS terminal 210 as if POS terminal 210 scanned a printed coupon for that item.

When performing validation, coupon/item validation logic 170 within POS controller 220 validates the digital coupon to the items purchased using either offer registry 180 or family code database 185. Furthermore, validation logic 170 reviews the digital coupons to see if ‘valid’ items in sufficient quantities have been purchased for redemption. When ‘valid’ items in sufficient quantities have been purchased to redeem a coupon, logic 170 causes the redeemed coupon to be marked as ‘redeemed’ or removed from the user's holding account in storage unit 200 so it cannot be reused. The digital coupon is then added to retailer redeemed account 190. Any items used to redeem a coupon are marked as such so that they may not be used to redeem subsequent coupons.

In the event that an item required for the redemption of a digital coupon be voided or returned within the transaction, the coupon redemption will be reversed, and the digital coupon will be returned to the user's holding account 140. The digital coupon will be removed from the retailer redeemed account 190, and any other items originally used to redeem the digital coupon will be unmarked and made available for other coupon redemptions.

When not configured to perform digital coupon validation, POS controller 220 fetches the digital coupons previously retained in storage unit 200 that correspond to the scanned or keyed items at POS terminal 210 for possible redemption. These digital coupons are merely downloaded to coupon fetching logic 250 for uploading into POS terminal 210. POS terminal 210 performs the validation, namely a single tiered validation unlike the dual tier validation described above.

According to yet another embodiment of the invention, a single tier validation mechanism is utilized as described above. However, the printing of digital coupons stored within retailer redeemed account 190 is restricted by software that controls the printing of digital coupons at the retailer. For instance, where POS controller 220 handles the printing of redeemed digital coupons, POS controller 220 executes software that imposes printing restrictions such as limiting the number of prints of a digital coupon (e.g., quantity identified on the digital coupon), limiting the printing of digital coupons to the number of items purchased provided there is no quantity limits or other restrictions on the digital coupon, and the like.

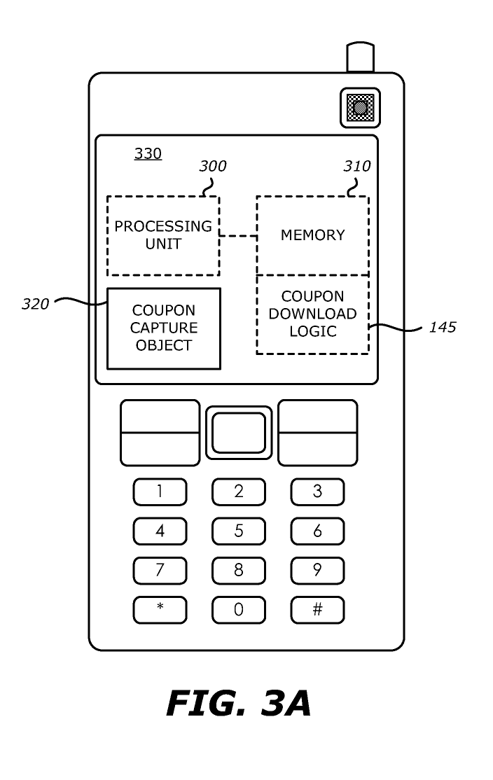

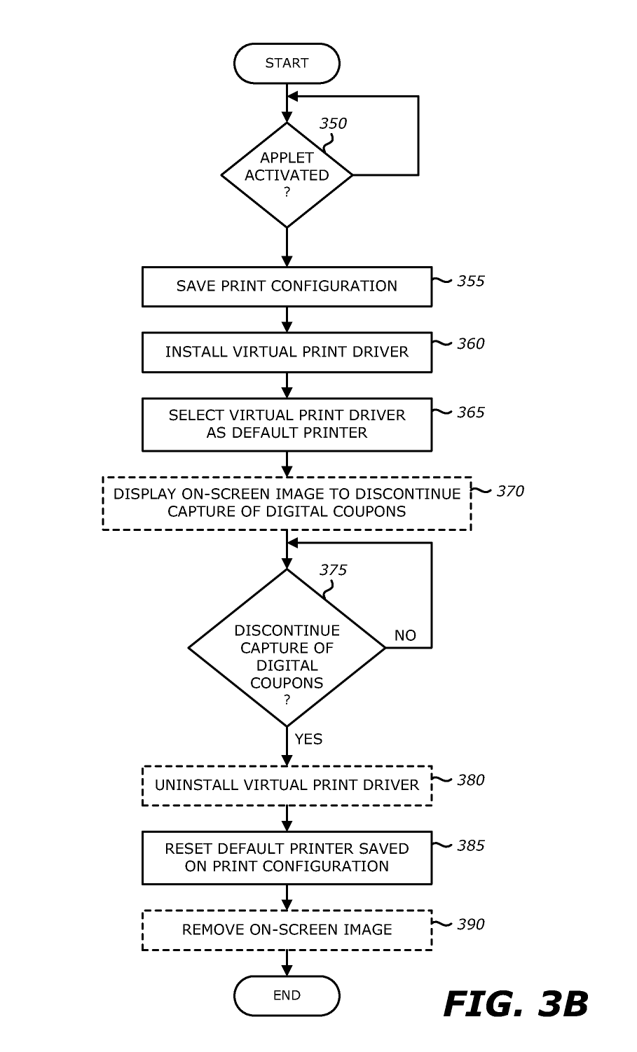

Referring now to FIGS. 3A-3B, exemplary embodiment of the architecture and operations for configuring electronic device 120 to support digital coupon re-transmission is shown. With respect to FIG. 3A, electronic device 120 includes a processing unit 300 in communication with a memory unit 310. Memory unit 310 is a machine readable medium that is adapted to receive and store coupon capturing logic 145, for example a software module (e.g., an application with an applet) that may be configured to generate an object 320 for display on a display screen 330 of electronic device 120 to more easily activate the application that controls the re-transmission of downloaded digital coupons to the user's holding account.

Herein, when object 320 is selected by the user, the applet is activated and identifies the current default printer supporting electronic device 120 as represented by block 350 of FIG. 3B. Thereafter, the print configuration is saved (block 355), and a virtual print driver is installed that will capture digital coupon images (block 360). This “virtual print driver” is software that re-transmits images of one or more selected digital coupons over a network for remote storage that effectively constitutes the “virtual printer”. Thus, the operating system of electronic device 120 may consider that the image is being printed but, in fact, the digital coupon image is being re-transmitted to storage unit 110/200 of FIGS. 1-2. Storage unit 110/200 is accessible by one or more retailers that are willing to redeem the digital coupon.

In another embodiment of this invention, when the “virtual print driver” is activated by the user, any information selected by the user for printing, including the digital coupon images, will be captured and re-transmitted by the virtual print driver to the user's holding account.

Thereafter, the virtual print driver is set as the default driver (block 365) and, as an optional feature and indicated by dashed border lines in block 370, an on-screen image may be displayed on display screen 330 of FIG. 3A. This image, when activated, discontinues the capturing of digital coupons by the electronic device (block 375). Thereafter, the original default printer may be restored.

More specifically, either performed automatically upon completion of capturing the digital coupons or when the on-screen image is activated by the user, the print configuration data is recovered to set the default printer back to its current state before the virtual print driver was set as the default driver (block 385). As an optional feature, before recovery of the default printer state, the virtual print driver may be uninstalled (block 380). Thereafter, if utilized, the on-screen image is removed (block 390).

In lieu of implementing an applet to turn on the digital coupon capture feature, it is contemplated that installation of the capture application could have the capture logic continuously activated without a need for an applet. For this embodiment, it would be scanning everything being printed and automatically extract digital coupons whenever it identified a coupon barcode.

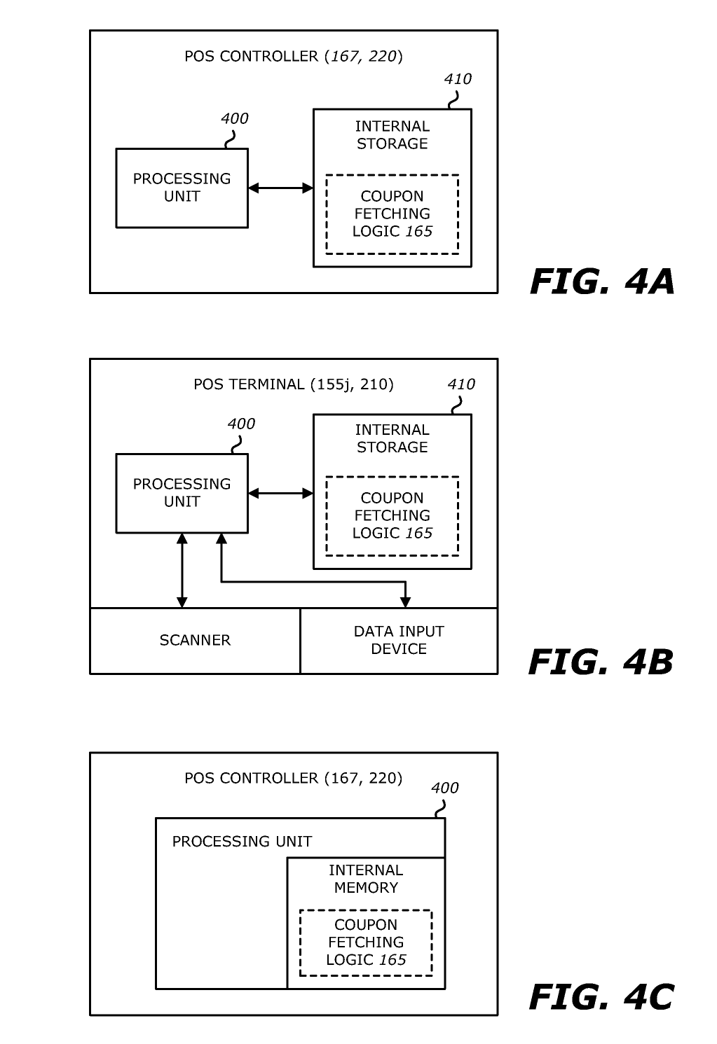

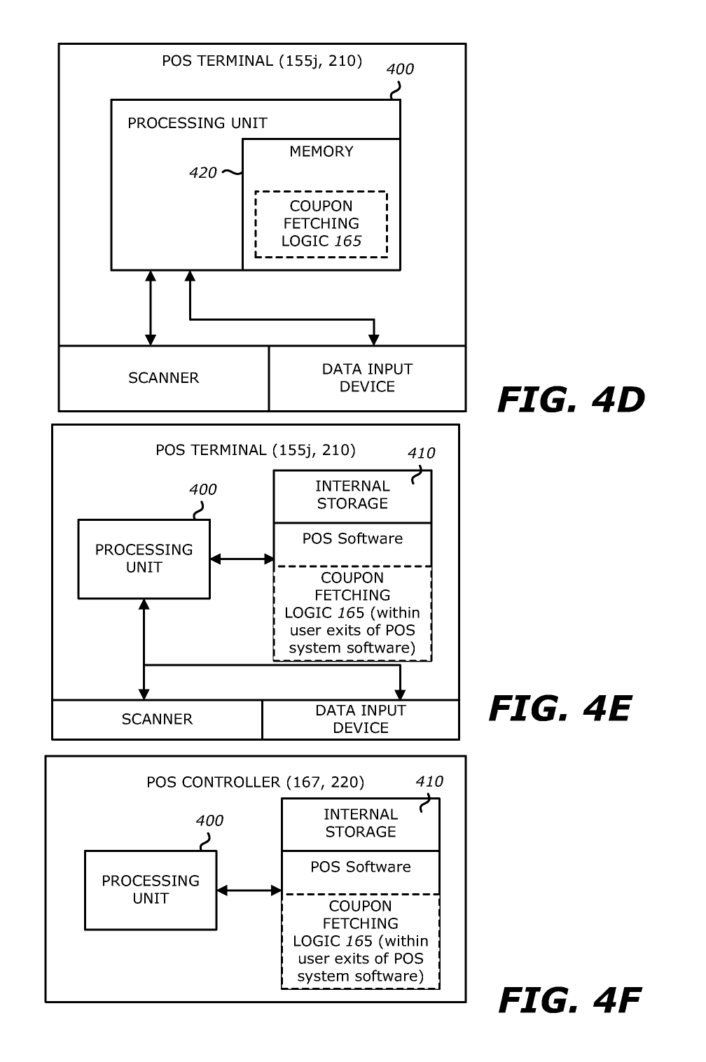

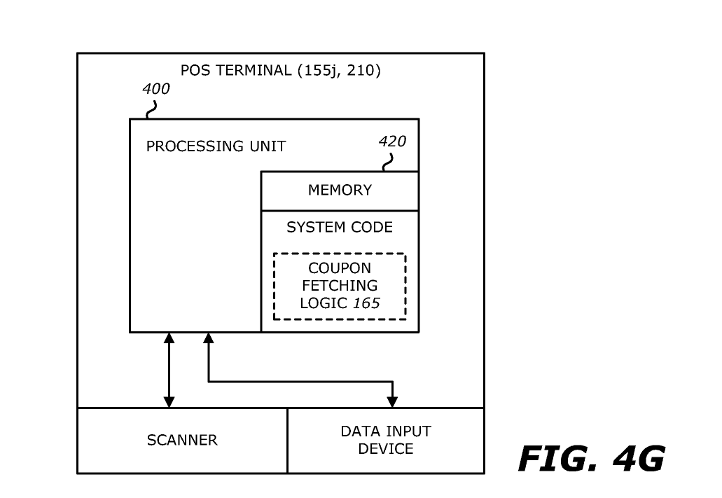

Referring now to FIGS. 4A-4G, exemplary embodiments of operations for configuring a retailer's POS system 150 of FIG. 1 or POS system 205 of FIG. 2 to support digital coupon validation and clearance is shown. According to one embodiment of the invention, POS system 150 (or 205) comprises a controller 167 (or 220) that is adapted as a centralized processing unit for one or more POS terminals 155/210. The implementation of coupon fetching logic 165 will vary based on the POS hardware and software being used by the retailer.

According to one potential implementation, as shown in FIGS. 4A and 4B, coupon fetching logic 165 may be a software module operating as a driver that is uploaded into internal storage 410 and executed by processing unit 400 of controller 167/220 (and/or each POS terminal 155/210). Hence, controller 167/220 (and/or POS terminal 155/210) can receive stored digital coupons for an identified user.

According to another exemplary implementation, coupon fetching logic 165 may be a firmware that is installed in internal memory 420 of processing unit 400 implemented within controller 167/220 (and/or each POS terminal 155/210) as shown in FIGS. 4C and 4D. Yet another exemplary implementation may feature the functionality of coupon fetching logic 165 being implemented within user exits of POS software on each POS terminal 155/210 (and/or controller 167/220) as shown in FIGS. 4E and 4F. Yet another exemplary implementation, as shown in FIG. 4G, may include the functionality of coupon fetching logic 165 being implemented within system code that controls POS terminals 155/210 of FIGS. 1 and 2.

Since the implementation will vary by POS system and in order to minimize its impact on the response times of POS system 150/205, coupon fetching logic 165 operates as a real-time interface to capture data from and insert data into POS transactions. It will communicate with coupon/item validation logic 170 for validation and decision making.

The data to be captured from POS transactions would be a transaction beginning and end, as well as any point where a total is performed; a transaction identifier; a POS number; a customer identification, such as a phone number, loyalty/club/frequent shopper card number, personal identification number (pin), credit card number, biometric data (e.g. fingerprint), or the like; purchased items including barcode number or PLU, quantity purchased, and unit price; coupons redeemed; and voided items, coupons, and transactions.

The data to be inserted into POS transactions may include, but is not limited or restricted to a customer's loyalty/club/frequent shopper card number if another method of identification was done by the customer; coupons to be redeemed, including barcode number and, for “free” coupons, coupon value; and coupons to be reversed due to voided products.

B. System Operation Flowchart

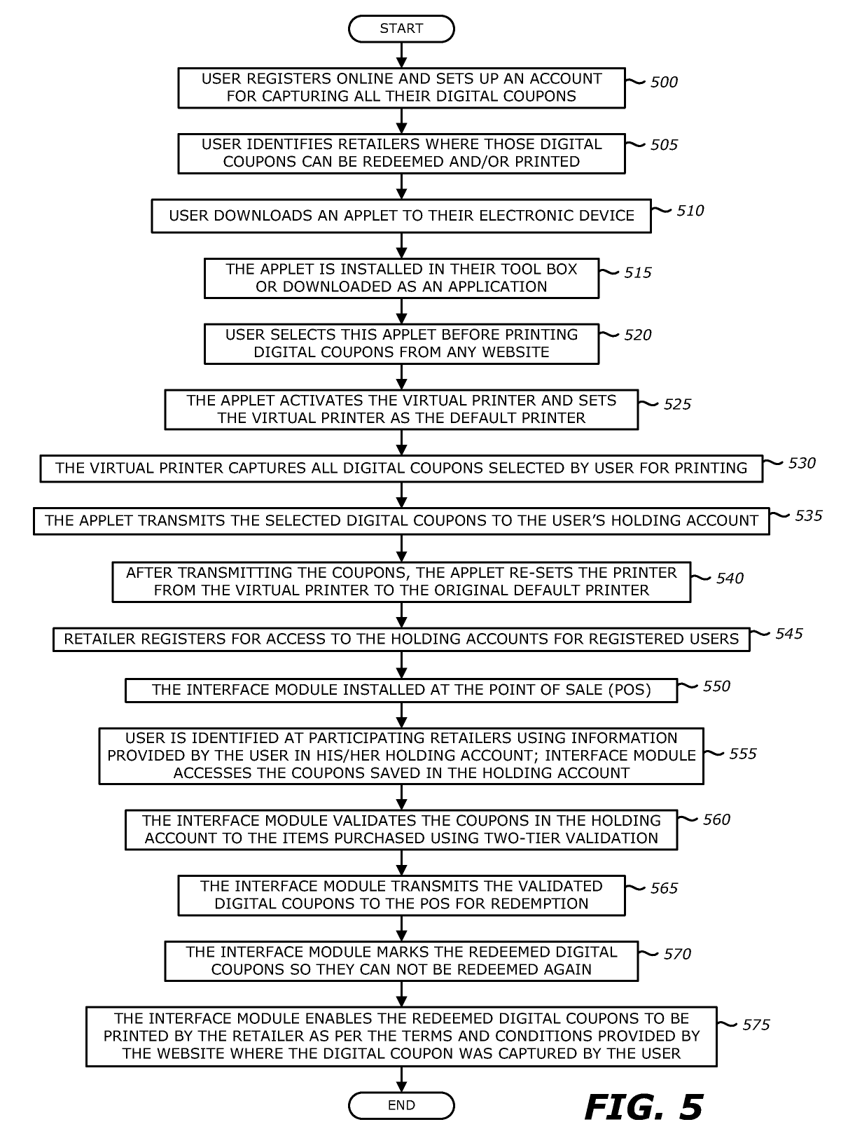

Referring to FIG. 5, an exemplary embodiment of the digital coupon distribution process supported by the coupon redemption system is shown. First, the user registers with an entity to establish a coupon holding account for retaining his/her digital coupons (block 500). When setting up a coupon holding account, the user identifies the participating retailers where he or she intends to redeem coupons and how the user shall be identified at these participating retailers (block 505). The method of identification may vary by retailer and includes one or more of the following: (1) retailer club/loyalty/frequent shopper card; (2) home telephone number; (3) mobile telephone number; (4) pin number; (5) biometrics (e.g. fingerprint); or (6) ATM/credit/debit card

In addition to registering and establishing a coupon holding account, the user installs digital coupon capturing logic on his/her electronic device. As an illustrative example, the digital coupon capturing logic may include a software application featuring an applet that is installed in the toolbox utility of the electronic device (blocks 510 and 515). According to one embodiment of the invention, the application may be downloaded from a website, although it is contemplated that the application may be downloaded from a portable recording medium (e.g., digital versatile disc “DVD”, compact disc “CD”, etc.). According to one embodiment of the invention, the application includes a virtual print driver, an applet (or icon) displayed on the desktop or toolbar, and software underlying the applet to set a targeted storage unit, which is accessible by POS systems of participating retailers and considered to be the “virtual printer,” as the default printer.

Once the application has been installed on the user's electronic device, the user merely needs to select the applet, prior to printing any digital coupons, to activate the virtual print driver (block 520). The virtual print driver will then alter the print setting so that digital coupons that are attempted to be printed are instead re-routed to the user's holding account (block 525).

With this “virtual printer” now set as the default printer, any coupons that are “printed” by the user would be captured by the virtual print driver instead of printing on paper (block 530). When receiving a digital coupon, the virtual print driver would transfer the digital coupon image over a network (e.g., Internet) to the holding account that the user had previously established (block 535). According to one embodiment of the invention, the barcode information on the digital coupon images is converted to readable characters, either by the virtual print driver or by the coupon fetching logic, to aid in identifying the coupons and to determine the items necessary for redemption of the coupons. The virtual print driver then resets the original printer as the default printer either automatically when the coupons have been captured, or manually by way of a prompt to the user (block 540).

In order to participate in the electronic capture and redemption of digital coupons, a retailer also registers as a participating retailer (block 545). In addition, the retailer installs logic (e.g., coupon caching logic) to function as an interface module and for communicating between the POS system at the retailer and holding accounts that are stored locally at the retailer or off-site (block 550). Also, if not installed already, the retailer would install software to print out the redeemed digital coupons in the retailer redeemed account. The interface module will keep track of the items purchased and select the digital coupons from the user's holding accounts.

When checking out at the retailer, the customer identifies himself or herself at the POS terminal with one of the methods of identification that he has previously registered (block 555). At that time, the user identification is sent over a network connection to the holding accounts, and the coupons previously retained in the user's holding account are selected for possible redemption.

As items are scanned/purchased on the POS terminal, the coupon fetching logic (also referred herein as the “interface module”) validates the coupons stored in the holding accounts to the items purchased using either the ‘offer registry’ or the ‘family code database’ as described above (block 560). The “family code database” provides a list of items that fall within certain family codes, which are generally used by the retailers to validate the coupons. An “offer registry” is a list of specific items that apply for a coupon, as defined by the manufacturer or provider of such items.

The interface module continually reviews the selected coupons to see if ‘valid’ items in sufficient quantities have been purchased for redemption. When ‘valid’ items in sufficient quantities have been purchased to redeem a coupon, the interface module transmits the coupon to the POS terminal (block 565). The redeemed coupon is tagged or removed from the user's account so it cannot be reused (block 570). The coupon is then added to the retailer's redeemed coupon account. Also, any items used to redeem a coupon may be marked as such so that they may not be used to redeem subsequent coupons.

Should an item required for the redemption of a coupon be voided or returned within the transaction, the coupon redemption will be reversed, and the coupon will be returned to the user's holding account. The coupon will be removed from the retailer's account of redeemed coupons, and any other items originally used to redeem the coupon will be unmarked and made available for other coupon redemptions.

The interface module installed at the retailer will enable the retailer to print out the redeemed coupons as per the terms and conditions stated in the website where the coupon was originally captured (block 575). The retailer will print out the coupons that have been redeemed and add to their account of redeemed coupons and, then, submit them for redemption through their standard clearing process for collection.

As an additional option, the coupon printed by the retailer may include, in addition to the coupon image and information captured from the original website, some of the redemption details such as the user identification, item purchased for the coupon, retailer ID number, date and time of redemption, cash receipt number, etc. This additional redemption details may provide additional security to the coupon issuers that the coupon was redeemed by a real customer for a valid product.

Of course, as an alternative to the user installing the application and applet, this digital coupon distribution process may include an application programming interface (API) for third-party online coupon providers. A third-party coupon provider can then use this API to directly send coupon images and pertinent coupon redemption details to the user's holding account and, thus, provide seamless integration into their online site.

For retailers using POS systems for which no interface module has been written or for which the retailer does not wish to install an interface module on his POS system, this method includes an alternative to automatic coupon redemption. The alternative is to install a separate, intelligent device at each POS terminal for printing a user's coupons on paper. The device will have a display screen, keypad, and printer and will communicate directly with the storage unit featuring the holding accounts.

At checkout, then, the user would enter their identification on the device, select coupons from their account for printing, and hand them to the checkout clerk like any other paper coupon. When printed by the device, the coupons will be marked as redeemed, and removed from the user's holding account so they may not be reused.

In another embodiment of this invention, the coupon images and any other pertinent coupon redemption details captured by the user from various websites into their holding accounts can be transmitted to the retailer's loyalty program through an API interface or any other method of transmission. Thereafter, the retailer may validate and redeem those coupons through their own loyalty programs using the validation logic built within their POS systems.

While the invention has been described in terms of several embodiments, the invention should not be limited to only those embodiments described, but can be practiced with modification and alteration within the spirit and scope of the appended claims set forth in the subsequent non-provisional application. The description is thus to be regarded as illustrative instead of limiting.

What is claimed is:

1. An electronic device comprising:
an input device;
a memory adapted to store a virtual print driver; and
a processor in communication with the memory, the processor, in response to signaling from the input device, is configured to save a current print configuration of the electronic device and select the virtual print driver as a default printer so that, when an image is selected for printing, the image is captured and re-transmitted to a storage unit accessible to a retailer.

2. The electronic device of claim 1, wherein the image is not printed by the electronic device but rather is re-transmitted.

3. The electronic device of claim 1, wherein the image is a digital coupon image.

4. The electronic device of claim 3, wherein the input device is a mouse and the signaling from the input device is a mouse click to print the digital coupon image.

5. The electronic device of claim 3, wherein the input device is a keyboard and the signaling from the input device is an entry from the keyboard to print the digital coupon image.

6. The electronic device of claim 3, wherein virtual print driver, when the digital coupon image is selected for printing, captures the digital coupon image and re-transmits the digital coupon image while an operating system running on the electronic device considers the digital coupon image is being printed.

7. The electronic device of claim 3, wherein the processor to automatically return the electronic device to the current print configuration in which the default printer is now a printer in communication with the electronic device.

8. The electronic device of claim 1 being in communication with the storage unit being a holding account that is adapted to receive the image being a digitized image of a coupon.

9. The electronic device of claim 8 being in communication with the storage unit being the holding account that is adapted to also receive a digitized image of a coupon directly from a coupon issuer.

10. The electronic device of claim 9 being in communication with the storage unit being the holding account that is configured for communication with a point-of-sale (POS) system.

11. The electronic device of claim 1 being in communication with the storage unit being a first holding account that is adapted to receive the image being a first digitized image of a coupon targeted for one user and a second holding account that is adapted to receive a second digitized image of a coupon targeted for another user.

12. Software embodied in a computer readable medium and executed by a processing unit to perform the operations of:
retrieving a digital coupon; and
re-transmitting the digital coupon to a remotely located storage seamlessly while emulating printing of the digital coupon, the digital coupon being configured for subsequent downloading to a point-of-sale system for applying a discount to a purchase of an item.

13. The software of claim 12, wherein prior to retrieving the digital coupon, the processing unit further performing the operations of:
saving a print configuration for an electronic device implemented with the processing unit; and
installing a virtual print driver as a default printer so that, when the digital coupon is selected for printing, the digital coupon is retrieved and re-transmitted to the remotely located storage accessible by the point-of-sale system.

14. The software of claim 13, wherein the processing unit further performing the operations of:
resetting the print configuration of the electronic device to remove the virtual print driver as the default printer after the digital coupon has been re-transmitted to the remotely located storage.

15. A method comprising:
(1) saving a print configuration for an electronic device; and
(2) installing a virtual print driver on the electronic device, the virtual print driver being installed so that, when a digital coupon image is selected for printing, the digital coupon image is captured and re-transmitted over a network for remote storage without local printing of the digital coupon image.

16. The method of claim 15 further comprising:
(3) restoring the print configuration for the electronic device by removing the virtual print driver as a default printer.

17. The method of claim 15, wherein the remote storage is accessible by a point-of-sale system implemented at a retailer.

18. The method of claim 15, wherein the installing of the virtual print driver includes setting the virtual print driver as a default printer so that, when the digital coupon image is selected for printing, the digital coupon image is captured and re-transmitted while an operating system running on the electronic device considers that the digital coupon image is being printed.

19. The method of claim 16, wherein the processor to restoring of the print configuration is performed automatically.
